(19) United States
(12) Patent Application Publication
(10) Pub. No.: US 2007/0288472 A1
(43) Pub. Date: Dec. 13, 2007

(54) Transaction processing system and method

(76) Inventor: Paul G. Rivera, Seffner, FL (US)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 11/450,522

(22) Filed: Jun. 9, 2006

(51) Int. Cl. G06F 17/30

(52) U.S. Cl. 707/10

(57) ABSTRACT

A card sub-system includes a negative display unit and a positive display unit and means for transmitting transaction data. A transaction sub-system includes terminals adapted to receive transaction data transmitted from the card sub-system. A server sub-system is adapted to receive transaction data from the transaction sub-system and adapted to transmit transaction data and account information. An EFT network sub-system is included for receiving transaction data from the transaction sub-system and delivering it to the application server and for receiving transaction data and account information from the server sub-system. A method includes the manipulation and transfer of data within and between the sub-systems.

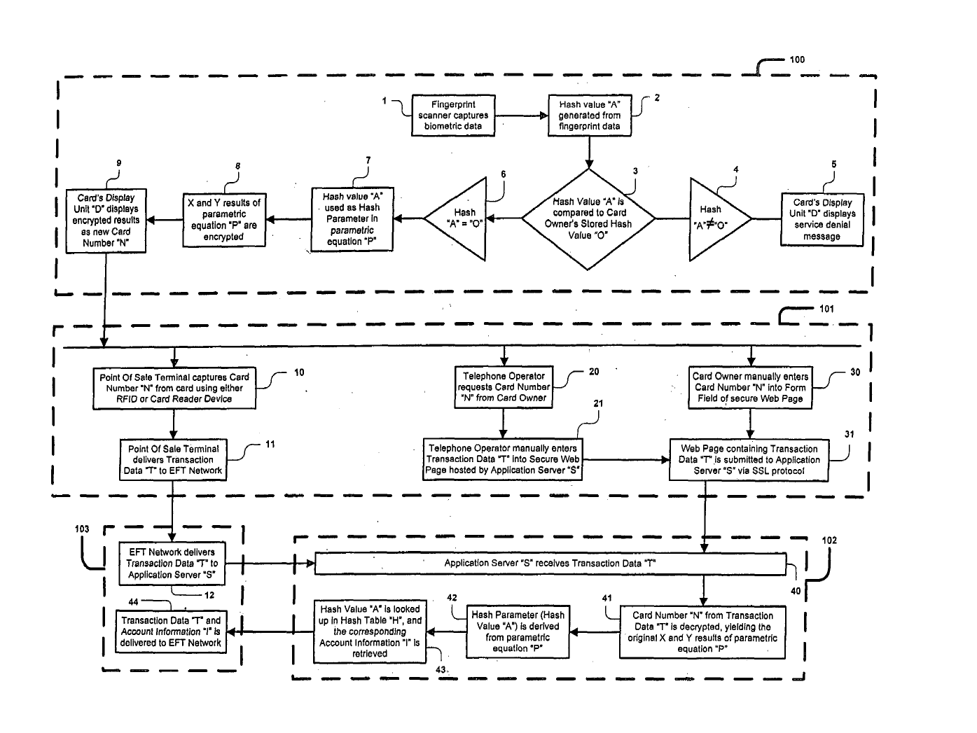

### BACKGROUND OF THE INVENTION

1. Field of the Invention

The present invention relates to a transaction processing system and method and more particularly pertains to conducting business electronically in a secure and convenient manner.

2. Description of the Prior Art

The use of business systems is known in the prior art. More specifically, business systems previously devised and utilized for the purpose of conducting business electronically are known to consist basically of familiar, expected, and obvious structural configurations, notwithstanding the myriad of designs encompassed by the crowded prior art which has been developed for the fulfillment of countless objectives and requirements.

By way of example, U.S. Pat. No. 6,038,315 issued Mar. 14, 2000 to Strait relates to a Method and System for Normalizing Biometric Variations to Authenticate Users from a Public Data Base and That Ensures Individual Biometric Data Privacy. In addition, U.S. Pat. No. 6,182,076 issued Jan. 30, 2001 to Yu relates to a Web-based, Biometric Authentication System and Method. Further, U.S. Pat. No. 6,580,814 issued Jun. 17, 2003 to Ittycheriah relates to a System and Method for Compressing Biometric Models. Lastly, U.S. Patent Application Publication Number 2002/0056043 issued May 9, 2002 to Glass relates to a Method and Apparatus for Securely Transmitting and Authenticating Biometric Data over a Network.

While these devices fulfill their respective, particular objectives and requirements, the aforementioned patents do not describe a transaction processing system that allows conducting business electronically in a secure and convenient manner.

In this respect, the transaction processing system according to the present invention substantially departs from the conventional concepts and designs of the prior art, and in doing so provides an apparatus primarily developed for the purpose of conducting business electronically in a secure-and convenient manner.

Therefore, it can be appreciated that there exists a continuing need for a new and improved transaction processing system which can be used for conducting business electronically in a secure and convenient manner. In this regard, the present invention substantially fulfills this need.

### SUMMARY OF THE INVENTION

In view of the foregoing disadvantages inherent in the known types of business systems now present in the prior art, the present invention provides an improved transaction processing system. As such, the general purpose of the present invention, which will be described subsequently in greater detail, is to provide a new and improved transaction processing system and method which has all the advantages of the prior art and none of the disadvantages.

To attain this, the present invention essentially comprises a transaction processing system for conducting business electronically in a secure and convenient manner. The system includes a card sub-system including a fingerprint scanner and a Hash value “A” generator coupled to the fingerprint scanner with a comparator coupled to the generator for comparing fingerprint data from the generator to a fingerprint value “0” in a data base. The card sub-system also includes an unequal gate coupled to the comparator and a negative display unit coupled to the unequal gate for displaying a service denial message when the Hash value “A” does not equal the fingerprint value “0”. The card sub-system also includes an equal gate and a parametric equation “P” component coupled to the equal gate and an encryption component coupled to the parametric equation “P” component and a positive display unit coupled to the encryption component for displaying a service acknowledgment message when the Hash value “A” equals the fingerprint value “0” and for transmitting a new card number “N”. The card sub-system has a storage component for initial fingerprint data.

The system also comprises a transaction sub-system including a point of sales terminal and a telephone operator terminal and a secure web page terminal. Each of the terminals is adapted to receive data transmitted from the positive display unit of the card sub-system. The transaction sub-system also includes a transaction data “T” transfer component coupled to the point of sales terminal. The transaction sub-system also includes a transaction data “T” manual entry component coupled to the telephone operator terminal. The transaction sub-system also includes a transaction data “T” submission component coupled to both the secure web page terminal and the manual entry component.

Further, the system comprises a server sub-system including an application server with a decryption component coupled to the application server and a deriver component coupled to the decryption component and a retrieve component coupled to the deriver component. The application server is adapted to receive transaction data “T” from the submission component and the retrieve component is adapted to transmit transaction data “T” and account information “I”. The application server has a storage component for initial fingerprint data.

Lastly, the system comprises an electronic financial transaction, EFT, network sub-system including a retransfer component for receiving transaction data “T” from the transaction data “T” transfer component and delivering it to the application server. The EFT network sub-system also includes a delivery component for receiving transaction data “T” and account information “I” from the retriever component.

The invention also includes the method of providing the system as described above and the steps of manipulating and transmitting data within and between the sub-systems.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved transaction processing system and method which have all of the advantages of the prior art business systems and none of the disadvantages.

It is another object of the present invention to provide a new and improved transaction processing system and method which may be easily and efficiently manufactured and marketed.

It is further object of the present invention to provide a new and improved transaction processing system which is of durable and reliable constructions.

An even further object of the present invention is to provide a new and improved transaction processing system which is susceptible of a low cost of manufacture with regard to both materials and labor,-and which accordingly is then susceptible of low prices of sale to the consuming public, thereby making such transaction processing system economically available to the public.

Even still another object of the present invention is to provide a transaction processing system and method for conducting business electronically in a secure and convenient manner.

Lastly, it is an object of the present invention to provide a transaction processing system and method. The system includes a card sub-system having a negative display unit and a positive display unit and means for transmitting transaction data. The system also includes a transaction sub-system having terminals adapted to receive transaction data transmitted from the card sub-system. The system also includes a server sub-system adapted to receive transaction data from the transaction sub-system and adapted to transmit transaction data and account information. The system further includes an EFT network sub-system for receiving transaction data from the transaction sub-system and delivering it to the application server and for receiving transaction data and account information from the server sub-system. The method includes the manipulation and transfer of data within and between the sub-systems.

These together with other objects of the invention, along with the various features of novelty which characterize the invention, are pointed out with particularity in the claims annexed to and forming a part of this disclosure.

For a better understanding of the invention, its operating advantages and the specific objects attained by its uses, reference should be had to the accompanying drawing and descriptive matter in which there is illustrated preferred embodiment of the invention.

### BRIEF DESCRIPTION OF THE DRAWING

The invention will be better understood and objects other than those set forth above will become apparent when consideration is given to the following detailed description thereof. Such description makes reference to the annexed drawing which is a schematic illustration of a transaction processing system and method constructed in accordance with the principles of the present invention.

### DESCRIPTION OF THE PREFERRED EMBODIMENT

With reference now to the drawing, the preferred embodiment of the new and improved transaction processing system embodying the principles and concepts of the present invention.

The present invention, the transaction processing system and method is comprised of a plurality of components and steps. Such components in their broadest context include a card sub-system, a transaction sub-system, a server sub-system and an electronic financial-transaction, EFT, network sub-system. Such steps include the manipulation and transmission of date within and between the sub-stations. Such components are individually configured and correlated with respect to each other so as to attain the desired objective.

More specifically, the system of the present invention includes a transaction processing system for conducting business electronically in a secure and convenient manner. The system comprises, in combination, a card sub-system 100 including a fingerprint scanner 1 and a Hash value “A” generator 2 coupled to the fingerprint scanner. A comparator 3 is coupled to the generator for comparing fingerprint data from the generator to a fingerprint value “0” in a data base. The card sub-system also includes an unequal gate 4 coupled to the comparator and a negative display unit 5 coupled to the unequal gate for displaying a service denial message when the Hash value “A” does not equal the fingerprint value “0”. The card sub-system also includes an equal gate 6 and a parametric equation “P” component 7 coupled to the equal gate and an encryption component 8 coupled to the parametric equation “P” component and a positive display unit 9 coupled to the encryption component for displaying a service acknowledgment message when the Hash value “A” equals the fingerprint value “0” and for transmitting a new card number “N”. The card sub-system has a storage component for initial fingerprint data.

The system also comprises a transaction sub-system 101 including a point of sales terminal 10 and a telephone operator terminal 20 and a secure web page terminal 30. Each of the terminals is adapted to receive data transmitted from the positive display unit of the card sub-system. The transaction sub-system also includes a transaction data “T” transfer component 11 coupled to the point of sales terminal. The transaction sub-system also includes a transaction data “T” manual entry component 21 coupled to the telephone operator terminal. The transaction sub-system also includes a transaction data “T” submission component 31 coupled to both the secure web page terminal and the manual entry component.

Further, the system comprises a server sub-system 102 including an application server 40 with a decryption component 41 coupled to the application server and a deriver component 42 coupled to the decryption component and a retrieve component 43 coupled to the deriver component. The application server is adapted to receive transaction data “T” from the submission component and the retrieve component adapted to transmit transaction data “T” and account information “I”. The application server has a storage component for initial fingerprint data.

Lastly, the system comprises an electronic financial transaction EFT network sub-system 103 including a transfer component 12 for receiving transaction data “T” from the transaction data “T” transfer component and delivering it to the application server. The EFT network sub-system also includes a delivery component 44 for receiving transaction data “T” and account information “I” from the retrieve component.

The method of the present invention includes the steps of providing the apparatus as described above and the further step of manipulating and transferring data within and between the sub-stations. More specifically, the steps include first scanning the fingerprint of a card holder prior to any financial transaction for providing base initial fingerprint data for storing in both the card sub-system and the application server followed by supplemental scans of a fingerprint of a card holder which take place with each subsequent financial transaction. The steps also include generating a new card number in the card sub-system 100 if the scanned fingerprint of a user corresponds to a base fingerprint in the data base of the system, transferring the new card information from the positive display unit 9 to the transaction sub-system 101, transferring data from the submission component 31 to the application server 40 and from the transfer component of the transaction sub-component to the retransfer component 12 of the EFT network sub-system then to the application server 40, and transferring data from the retriever component 43 to the delivery component 44.

The preferred apparatus for utilizing the system of the present invention is a smart card consisting of a microprocessor with integrated memory, an electronic paper display unit, and an embedded fingerprint scanner 1. When such an apparatus is employed in the system of the present invention, a card holder can initiate and conduct an electronic financial transaction by passing his or her finger over the fingerprint scanner. A first scan is prior to any financial transaction for providing base fingerprint data into both the card sub-system and the application server. Supplemental scans of a fingerprint of a card holder takes place with each subsequent financial transaction. The Figure schematically illustrates the entire process which the system uses to conduct the electronic financial transaction once the card holder has passed a finger over the scanner. The embedded fingerprint scanner 1 on the card creates a digital template which the microprocessor on the card sub-system 100 uses to input a generator 2, to generate a hash value hereafter referenced as hash value “A”.

It should be noted that the very first time the card holder passes a finger over this device there is no financial transaction. The system and process differs from prior systems and processes in that there is no financial transaction taking place during such first scan. Instead, hash value “A” and the card holder's account information, hereafter referenced as account information “I”, are added to the system's hash table, hereafter referenced as hash table “H”. This is a table in a database residing on the system's application server sub-system 102, which includes the application server “S”. Also, hash value “A” is permanently stored in the memory of the card sub-system 100. The hash value that is stored during this first fingerprint scan is hereafter referenced as hash value “O”.

During subsequent scans, presumably performed at the moment just before the card holder is about to conduct an electronic financial transaction, the microprocessor on the card sub-system 100 compares the stored hash value “0” with hash value “A” which is generated by the generator 2 and compared by comparator 3. This occurs each time for a financial transaction after a fingerprint scan by scanner 2. If the two hash values are not equal as determined by an unequal gate 4, then the card sub-system microprocessor will send a “service denied” message to be displayed by the electronic paper on the card's surface, hereafter referenced as the negative display unit “D”, and the process ends there.

If the two hash values are equal as determined by the equal gate 6, then hash value “A” is used as the hash parameter in a parametric equation component 7, hereafter referenced as parametric equation “P”. The resulting X and Y values are then encrypted by the microprocessor encryption component 8 and displayed on positive display unit “D” 9 as an encrypted string of alphanumeric characters. This string of characters is hereafter referenced as the card's new card number “N”.

At present, it is considered that any one of three terminal device types in the transaction sub-system 101 can complete the transaction by accepting the new card number “N”. The first terminal is any device equipped with either radio frequency identification, RFID, technology if the card is a contactless card, or a card reader device if the card is a contact card. An example of such a device may be a merchant's point Of sale terminal 10. A second terminal includes a telephone operator at an operator terminal 20 that is signed on to a secure web session hosted by application server “S” 21. An automated telephone system with secure access to application server “S” may request the card number. At a-third terminal, the card holder manually enters their new card number “N” onto a transactional-web page at a submission terminal 30.

In the first case, the device transmits to the EFT Network 11, the transaction data which includes card number “N”, and hereafter referenced as transaction data “T”. The EFT Network sub-system 103 then delivers transaction data “T” to application server “S” 12. In the other two cases, transaction data “T” is submitted directly to application server “S” submission component 31 using the secure sockets layer protocol.

In all cases, once application server 40 “S” receives transaction data “T”, the card number “N” is taken from transaction “T” and decrypted to obtain the original X and Y values resulting from parametric equation “P” component 41. Using the original X and Y values, the second parameter, application server “S” can derive the hash parameter, hash value “A”, from parameter equation “P” via deriver component 42 and use it, the hash value “A”, to query hash table “H” and retrieve the account information “I” via deriver component 43. Application server “S” then sends transaction data “T”, replacing the encrypted X and Y values with account information “I”, to an EFT network sub-system complete the financial transaction via delivery component 44.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by LETTERS PATENT of the United States is as follows:

1. A transaction processing system comprising:
a card sub-system including a negative display unit and a positive display unit and means for transmitting transaction data;
a transaction sub-system including terminals adapted to receive transaction data transmitted from the card sub-system;
a server sub-system adapted to receive transaction data from the transaction sub-system and adapted to transmit transaction data and account information; and
EFT network sub-system for receiving transaction data from the transaction sub-system and delivering it to the application server and for receiving transaction data and account information from the server sub-system.

2. The system as set forth in claim 1 wherein the card sub-system further includes a fingerprint scanner and a Hash value “A” generator coupled to the fingerprint scanner with a comparator coupled to the generator for comparing fingerprint data from the generator to a fingerprint value “0” in a data base, the card sub-system also including an unequal gate coupled to the comparator with the negative display unit coupled to the unequal gate for displaying a service denial message when the Hash value “A” does not equal the fingerprint value “0”, the card sub-system also including an equal gate and a parametric equation “P” component coupled to the equal gate and an encryption component coupled to the parametric equation “P” component with the positive display unit coupled to the encryption component for displaying a service acknowledgment message when the Hash value “A” equals the fingerprint value “0” and for transmitting a new card number “N”.

3. The system as set forth in claim 1 wherein the transaction sub-system wherein the terminals include a point of sales terminal and a telephone operator terminal and a secure web page terminal, each of the terminals adapted to receive data transmitted from the positive display unit of the card sub-system, the transaction sub-system further including a transaction data “T” transfer component coupled to the point of sales terminal, the transaction sub-system further including a transaction data “T” manual entry component coupled to the telephone operator terminal, the transaction sub-system further including a transaction data “T” submission component coupled to both the secure web page terminal and the manual entry component.

4. The system as set forth in claim 1 wherein the server sub-system includes an application server with a decryption component coupled to the application server and a deriver component coupled to the decryption component and a retrieve component coupled to the deriver component, the application server adapted to receive transaction data “T” from the submission component and the retrieve component adapted to transmit transaction data “T” and account information “I”.

5. The system as set forth in claim 1 wherein the EFT network sub-system includes a transfer component for receiving transaction data “T” from the transaction data “T” transfer component and delivering it to the application server, the EFT network sub-system also-including a delivery component for receiving transaction data “T” and account information “I” from the retrieve component.

6. A transaction processing system for conducting business electronically in a secure and convenient manner comprising, in combination:
a card sub-system including a fingerprint scanner and a Hash value “A” generator coupled to the fingerprint scanner with a comparator coupled to the generator for comparing fingerprint data from the generator to a fingerprint value “0” in a data base, the card sub-system also including an unequal gate coupled to the comparator and a negative display unit coupled to the unequal gate for displaying a service denial message when the Hash value “A” does not equal the fingerprint value “0”, the card sub-system also including an equal gate and a parametric equation “P” component coupled to the equal gate and an encryption component coupled to the parametric equation “P” component and a positive display unit coupled to the encryption component for displaying a service acknowledgment message when the Hash value “A” equals the fingerprint value “0” and for transmitting a new card number “N”, the card sub-system having a storage component for initial fingerprint data;
a transaction sub-system including a point of sales terminal and a telephone operator terminal and a secure web page terminal, each of the terminals adapted to receive data transmitted from the positive display unit of the card sub-system, the transaction sub-system also including a transaction data “T” transfer component coupled to the point of sales terminal, the transaction sub-system also including a transaction data “T” manual entry component coupled to the telephone operator terminal, the transaction sub-system also including a transaction data “T” submission component coupled to both the secure web page terminal and the manual entry component;
a server sub-system including an application server with a decryption component coupled to the application server and a deriver component coupled to the decryption component and a retrieve component coupled to the deriver component, the application server adapted to receive transaction data “T” from the submission component and the retrieve component adapted to transmit transaction data “T” and account information “I”, the application server having a storage component for initial fingerprint data; and
electronic financial transaction EFT network sub-system including a transfer component for receiving transaction data “T” from the transaction data “T” transfer component and delivering it to the application server, the EFT network sub-system also including a delivery component for receiving transaction data “T” and account information “I” from the retrieve component.

7. A transaction processing method for conducting business electronically in a secure and convenient manner comprising, in combination:
providing a card sub-system including a fingerprint scanner and a Hash value “A” generator coupled to the fingerprint scanner with a comparator coupled to the generator for comparing fingerprint data from the generator to a fingerprint value “0” in a data base, the card sub-system also including an unequal gate coupled to the comparator and a negative display unit coupled to the unequal gate for displaying a service denial message when the Hash value “A” does not equal the fingerprint value “0”, the card sub-system also including an equal gate and a parametric equation “P” component coupled to the equal gate and an encryption component coupled to the parametric equation “P” component and a positive display unit coupled to the encryption component for displaying a service acknowledgment message when the Hash value “A” equals the fingerprint value “0” and for transmitting a new card number “N”;
providing a transaction sub-system including a point of sales terminal and a telephone operator terminal and a secure web page terminal, each of the terminals adapted to receive data transmitted from the positive display unit of the card sub-system, the transaction sub-system also including a transaction data “T” transfer component coupled to the point of sales terminal, the transaction sub-system also including a transaction data “T” manual entry component coupled to the telephone operator terminal, the transaction sub-system also including a transaction data “T” submission component coupled to both the secure web page terminal and the manual entry component;
providing a server sub-system including an application server with a decryption component coupled to the application server and a deriver component coupled to the decryption component and a retrieve component coupled to the deriver component, the application server adapted to receive transaction data “T” from the submission component and the retrieve component adapted to transmit transaction data “T” and account information “I”;
providing an electronic financial transaction EFT network sub-system including a transfer component for receiving transaction data “T” from the transaction data “T” transfer component and delivering it to the application server, the EFT network sub-system also including a delivery component for receiving transaction data “T” and account information “I” from the retrieve component; and
manipulating and transferring data within and between the sub-systems.

8. The method as set forth in claim 7 and further including the step of scanning the fingerprint of a cardholder to generate initial fingerprint data prior to initiating any financial transaction and storing such initial fingerprint data in both the card sub-system and the server sub-system.
